(19) United States
(12) Patent Application Publication
(10) Pub. No.: US 2024/0245262 A1
(43) Pub. Date: Jul. 25, 2024

(54) Small Form Factor Food Warming And Holding Cabinet With Humidity Management System

(71) Applicant: InterMetro Industries Corporation, Wilkes-Barre, PA (US)

(72) Inventor: Jeffrey C. OLSON, Dallas, PA (US)

(21) Appl. No.: 18/412,866

(22) Filed: Jan. 15, 2024

Related U.S. Application Data
(60) Provisional application No. 63/440,626, filed on Jan. 23, 2023.

(51) Int. Cl. A47J 39/02; A47J 39/00

(52) U.S. Cl. CPC A47J 39/02; A47J 39/003; A47J 39/006

(57) ABSTRACT

A food holding and warming cabinet has a user-operated humidity management system. It has a hybrid heating system with both a hot air convection heating component and a radiant heating component. The humidity management system enables a user to manually control the introduction of humidity into the cabinet holding environment or the reduction or mitigation of the humidity within the cabinet holding environment.

### CROSS-REFERENCE TO RELATED APPLICATION

This application claims the benefit of U.S. Provisional Application No. 63/440,626, filed on Jan. 23, 2023. The entire disclosure of the above application is incorporated herein by reference.

### FIELD

The present disclosure relates to food holding and warming equipment and, more specifically, to a humidity management system for the equipment.

### BACKGROUND

This section provides background information related to the present disclosure which is not necessarily prior art.

Food holding and warming cabinets are known in the food service industry and are used to keep cooked food ready-to-serve by maintaining the cooked food at an appropriate temperature without diminishing food quality.

Small form factor holding and warming cabinets are sized to accept vertically stacked gastronorm steam pans and/or sheet pans. The footprint of these cabinets make them desirable under conditions where kitchen space is limited, or to allow the cabinets to be positioned closer to a point-of-use, such as on top of or beneath a table or workstation. Additionally, small food holding and warming cabinets are advantageous when needing to hold smaller quantities of food or varieties of foods having different holding and/or warming requirements.

The relative humidity inside a holding cabinet can vary a great deal, depending on the type and quantity of food being held, how the food was prepared, and how long the food is held in the cabinet prior to serving. In order to maintain the quality of the food during holding, some degree of control over the relative humidity in the holding environment of the cabinet is desired. In some instances, too high a relative humidity can cause crisp food to become soft or soggy and in other cases too little humidity can cause food to dry out.

Known heated holding cabinets can include one or more manual vents that can open or close to passively address humidity control, such as by allowing or preventing moist air from escaping the cabinet holding environment. Other known cabinets include closed-loop automated systems that are programmed to maintain the relative humidity in the cabinet holding environment to a desired relative humidity set point.

### SUMMARY DESCRIPTION

This section provides a general summary of the disclosure and is not a comprehensive disclosure of its full scope or all of its features.

The present disclosure provides a small form factor, food holding and warming cabinet including a user-operated humidity management system.

In one aspect of the disclosure, the food holding and warming cabinet employs a hybrid heating system including both hot air convection heating component and radiant heating component. Together, the convection heating and radiant heating combine to provide a more even heat distribution throughout the cabinet holding environment.

In another aspect of the disclosure, a user-operated humidity management system enables a user to manually control the introduction of humidity into the cabinet holding environment or reduction or mitigation of the humidity within the cabinet holding environment. Humidity can be introduced into the cabinet holding environment through evaporation. In this regard, the radiant heating element can be employed to heat a pan of water (e.g., a gastronorm steam pan or water bath) placed adjacent or in proximity to the radiant heating element at or near the bottom or floor of the cabinet holding environment.

Alternatively, humidity in the cabinet holding environment can be reduced or mitigated by directing the hot, humid air being circulated through the cabinet holding environment to an outlet vent at an upper end of the cabinet. In addition, an inlet air vent can be included at a lower end of a door of the cabinet that, when opened, introduces ambient air from outside the cabinet holding environment into the flow of heated air circulating through the cabinet holding environment to further assist with humidity mitigation.

In another aspect of the disclosure, a bracket can be employed to enable the easy combination of multiple cabinets in a stacked arrangement.

In another aspect of the disclosure, the food holding and warming cabinet can have a variety of sizes, be stationary or mobile, and/or be adapted for use in various settings or applications such as on-counter, under-counter, wheeled and transport.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows views of several various embodiments of a food holding and warming cabinet of the present disclosure and in various combinations and arrangements;

FIG. 2 is a perspective view of an exemplary food holding and warming cabinet of the present disclosure showing the top cover of the cabinet removed to reveal the upper venting chamber;

FIG. 3 is a perspective view of an alternate embodiment of an exemplary food holding and warming cabinet of the present disclosure having door venting;

FIG. 4 is an exploded perspective view of a cabinet door for the exemplary food holding and warming cabinet of FIG. 3;

FIGS. 5A, 5B and 5C are exemplary operating states for the humidity management system for a food holding and warming cabinet of the present disclosure; and

FIG. 6 is an exploded, partial perspective view of two exemplary food holding and warming cabinets of the present disclosure illustrating the ability to configure the cabinets in a stacked arrangement with a stacking bracket.

Corresponding reference numerals indicate corresponding parts throughout the several views of the drawings.

### DESCRIPTION

Example embodiments will now be described more fully with reference to the accompanying drawings.

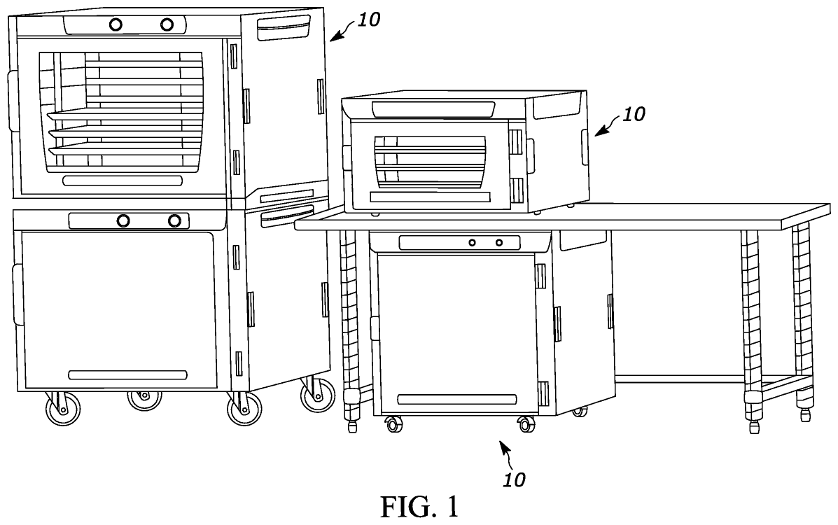

A food holding and warming cabinet according to the present disclosure is illustrated in FIGS. 1-6. The food holding and warming cabinet 10 includes an insulated cabinet housing 12 having a plurality of housing walls 14-20. The housing walls 14-20 enclose an interior space 22 of the cabinet 10 to receive food. The enclosed interior space 22 is defined opposing side walls 14, 18, a back wall 16, a top wall 24 and a floor 26. At least one of the side walls 14 includes or houses a duct or chimney 28 within the side wall 14 which communicates with the enclosed interior space 22. The side walls 14, 18 can include tray rails 30 to support pans or trays containing food held in the cabinet 10 (e.g., gastronorm pans).

A front side 20 of the housing provides an opening 32 into the interior space 22. A door 34 is attached to the front side 20 of the housing and is moveable between an opened position for providing access to the enclosed interior space 22 and a closed position for preventing access to and sealing the enclosed interior space 22 from the ambient environment outside of the cabinet 10.

Located above the top wall 24 of the interior space 22 is a first venting chamber 40. The first venting chamber 40 is in fluid communication with the duct 28 in the side wall 14. The first venting chamber 40 also includes a first vent opening 42 in fluid communication with the interior chamber 22. A fan 44 is disposed in the first venting chamber 40 proximate to the first vent opening 42. For example, an intake side of the fan 44 can be positioned directly over the first vent opening 42. The first vent opening 42 enables the fan 44 to circulate air between the enclosed interior space 22 and the first venting chamber 40, as further discussed. Vent openings 46 are to reduce the temperature in the top of the cabinet to protect the electronic components.

The food holding and warming cabinet 10 also includes a heating system 50 for heating the enclosed interior space 22. The heating system 50 can include both a convection heating component 52 and a radiant heating component 54.

The convection heating component 52 utilizes circulating hot air within and through the interior space 22 to heat the interior space 22 (and/or the food being held) to a desired temperature. The convection heating component 52 includes a first heating element 56 (i.e., an electric resistance heater) that is located within the duct 28 of the side wall 14. In operation, the fan 44 draws air from the enclosed interior space 22 through the first vent opening 42 and creates a negative pressure within the enclosed interior space 22. As this occurs, air is drawn through and/or into the first venting chamber 40 and into the duct 28. As the air circulates into and through the duct 28, the air necessarily comes into proximity with and/or passes across and/or through the first heating element 56 and the air is heated. The hot air then continues to circulate into and through the enclosed interior space 22, heating or maintaining a desired temperature of the space and/or food.

Optionally, in addition, the heating system can also include a radiant heating component 54. The radiant heating component 54 can include a second heating element 58 that is disposed at, near or in the floor of the enclosed interior space 22. The radiant element 54 is not optional in the current design, although it could be in future embodiments.

The radiant heating component 54 and the convection heating component 52 can be operable independently, alternately, and/or in combination to achieve an even and consistent heat distribution throughout the interior space 22 of the cabinet 10. The radiant element 54 is not independently operable in the current design, although it could be in future embodiments.

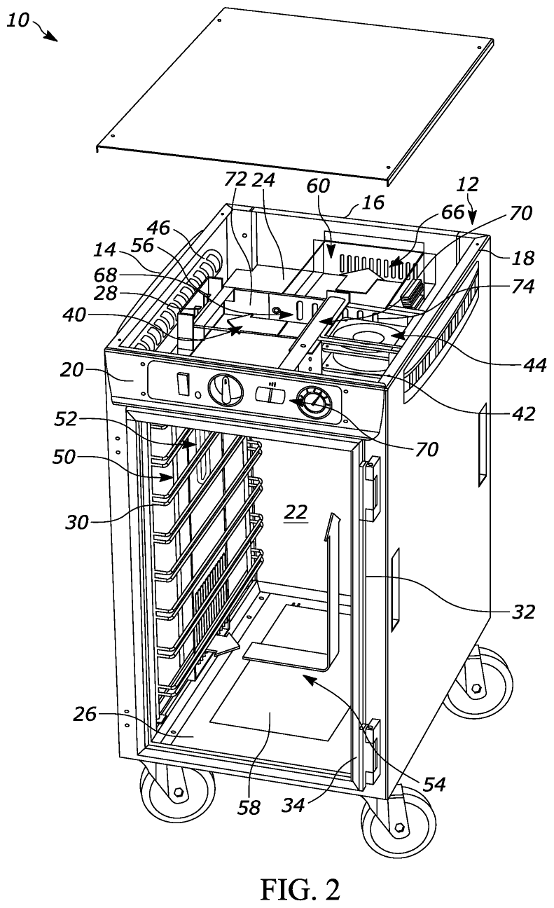

As shown in the figures and, particularly FIGS. 2-4 and 5A-5C, the food holding and warming cabinet 10 of the present disclosure can include a user-operated humidity management system 60.

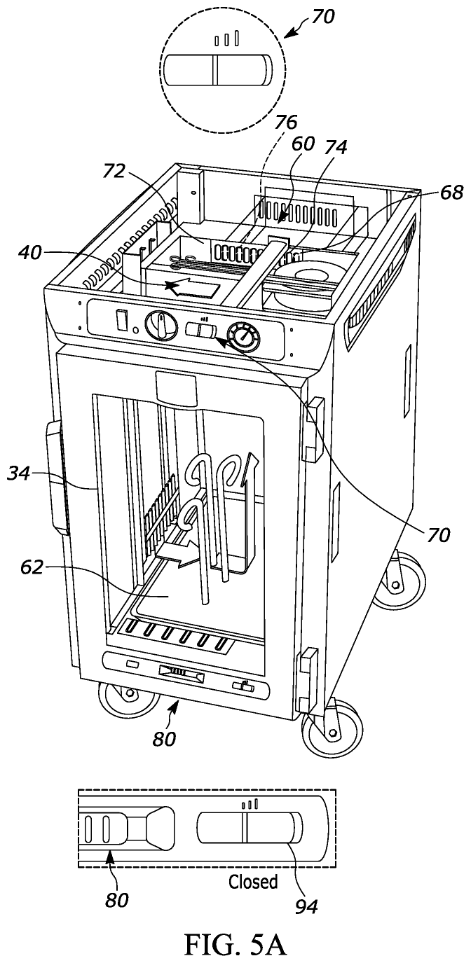

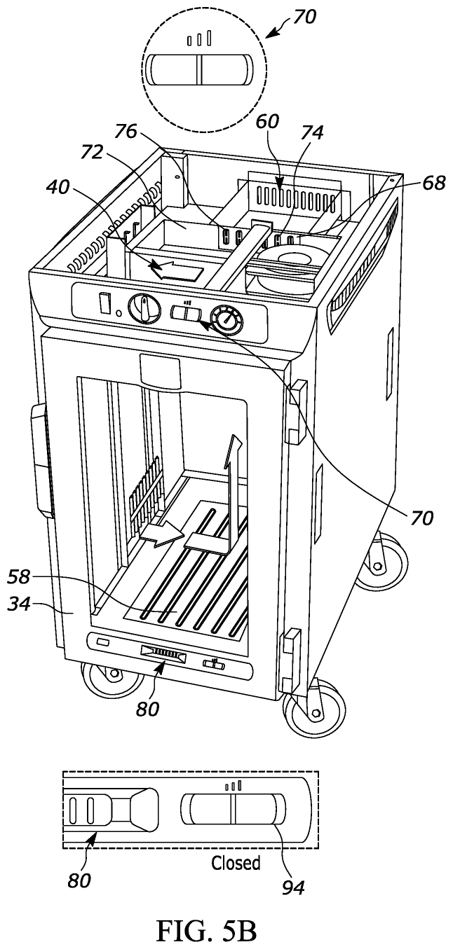

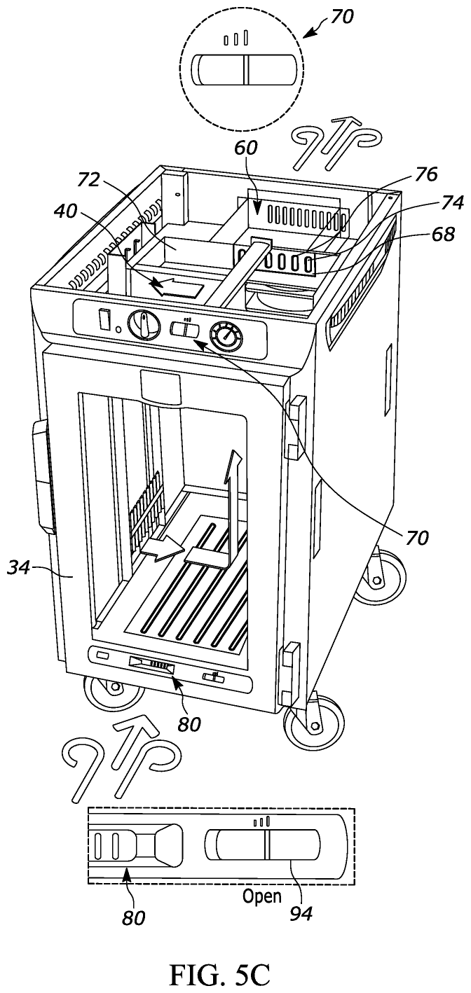

With reference to FIG. 5A, the humidity management system 60 can utilize the radiant heating component 54 to introduce humidity into the enclosed interior space 22 to increase the relative humidity. In this regard, a water bath 62 (e.g., a gastronorm pan containing water) can be placed in the interior space on or near the second heating element 58. The second heating element 58 can heat the water bath 62 to create water vapor or steam that can be introduced into the enclosed interior space 22 raising the relative humidity in the interior space. In addition, the circulating flow of hot air can also heat the water bath 62 and/or mix with the water vapor or steam into the airflow and help distribute the added moisture throughout the enclosed interior space.

Referring to FIGS. 2-4, 5B and 5C, the humidity management system 60 can also enable humidity mitigation (i.e., a reduction in the relative humidity) for the enclosed interior space 22 of the cabinet 10 that a user/operator can control and/or manipulate manually.

The humidity management system 60 is located above the top wall of the enclosed space of the cabinet and adjacent to the first venting chamber 40. The first venting chamber 40 is under positive pressure where the second venting chamber 60 has openings. This allows the humidity to be eliminated. The second venting chamber 60 can include a vent opening 66 from the second venting chamber 60 to the ambient environment outside of the cabinet 10 (i.e., an outlet vent). Preferably, the third vent opening outlets 66 at the rear of the cabinet 10. In addition, the second venting chamber 60 can include a baffle member 68 that selectively separates the second venting chamber 64 from the first venting chamber 40. The baffle member 68 can be movable between an opened condition where air flow between the first venting chamber 40 and the second venting chamber 60 is allowed, and a closed condition where air flow between the first venting chamber 40 and the second venting chamber 64 is prevented. A baffle operator 70 can be connected to the baffle member 68 and accessible to a user/operator. The baffle operator 70 enables a user/operator to manipulate the baffle member 68 between the opened and closed conditions.

With further reference to FIG. 2, the first venting chamber 40 can include a chamber wall 72 having at least one first slot 74 and, preferably, a plurality of first slots passing through the chamber wall. The baffle member 68, in turn, includes at least one second slot 76 and, preferably, a plurality of second slots passing through the baffle member 68. The baffle member 68 can be positioned against the chamber wall 72. The baffle member 68 is movable (e.g., slidable) relative to the chamber wall 72. Preferably, the chamber wall 72 and baffle member 68 are located close to the first vent opening and/or the exhaust side of the fan.

With reference to FIG. 5C, in the opened condition of the baffle member 68, the at least one second slot 76 at least partially aligns with the at least one first slot 74; that is, the first 74 and second 76 slots at least partially overlap such that an air passage between the first venting chamber 40 and the second venting chamber 60 is created by the first 74 and second 76 slot. In the closed condition of the baffle member 68, the at least one second slot 76 does not align with the at least one first slot 74; that is, the first and second slots do not overlap. As shown in FIG. 5B, in the closed condition, the first venting chamber 40 and the second venting chamber 60 are closed to one another and air does not pass through the first 74 and second 76 slots from the first venting chamber 40 to the second venting chamber 60.

It can be understood that the user/operator can manipulate the baffle operator 70 to control the amount of overlap between the first and second slots. As such, the baffle member 68 can be selectively movable by the user/operator from a closed condition (i.e., no overlap between the first 74 and second 76 slots) through at least a variety of partially opened 5conditions (i.e., where the overlap between the first 74 and second 76 slots is greater than zero but less than a maximum) to a fully opened condition (i.e., where the overlap between the first and second slots is at the maximum). Further, the baffle operator 70 can be associated with preset baffle positions or indicia to aid the user/operator when manipulating the baffle operator 70 to vary the opening and, therefore, the air flow, between the first venting chamber and the second venting chamber.

As illustrated in FIG. 5C, humidity mitigation for the enclosed interior space 22 of the cabinet 10 can be accomplished by the user/operator moving the baffle member 68 to the opened condition. In this respect, air from the enclosed interior space 22 of the cabinet 10 with a relative humidity higher than a desired value, can be ventilated to the ambient environment outside of the cabinet 10 through the second venting chamber 60. For example, humid air drawn by the fan 44 from the enclosed interior space 22 into the first venting chamber 40 can pass through the aligned first 74 and second 76 slots of the chamber wall 72 and baffle member 68 and into the second venting chamber 60 when the baffle member 68 is in the opened condition. From the second venting chamber 60, the humid air can pass through the third vent 66 opening and to the outside ambient environment. Replacement air can be drawn through the door vent.

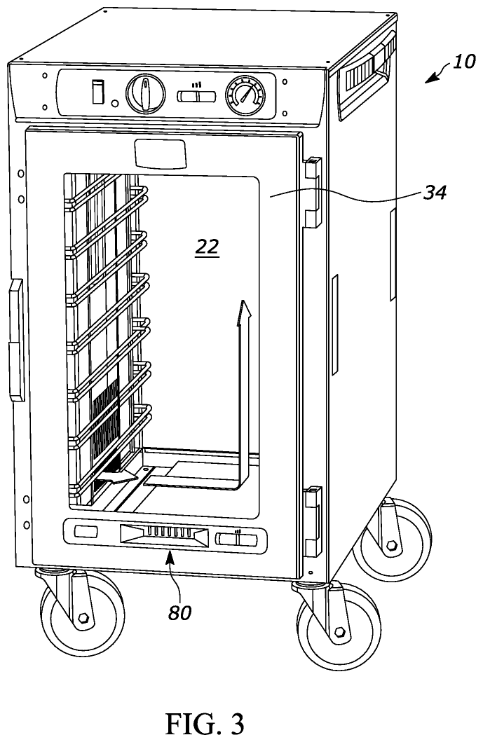

Referring to FIGS. 3, 4 and 5C, the food holding and warming cabinet 10 has a door 34 attached to the front of the cabinet housing 12. The door 34 can include a door vent assembly 80 that can optionally be included as part of the humidity management system 60.

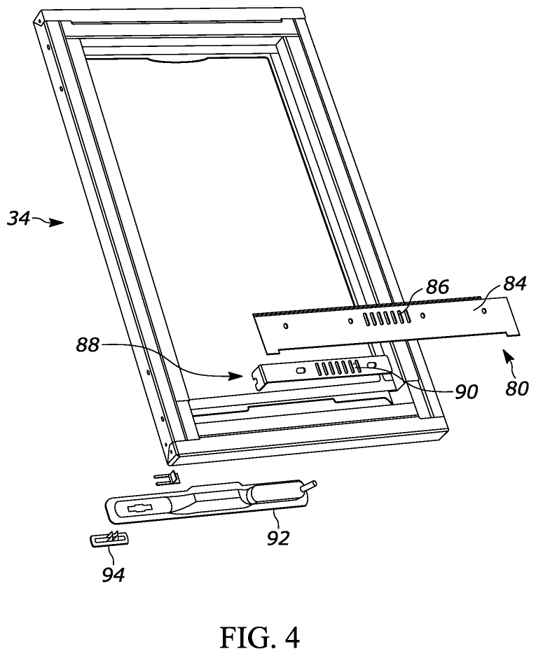

As seen in FIG. 4, the door 34 includes a door frame 82, and the door vent assembly 80 is attached to the door frame 82. The door vent assembly 80 can include a door vent member 84 having at least one third slot 86 passing through the door vent member 84, a door vent baffle member 88 having at least one fourth slot 90 passing through the door vent baffle 88, a door vent body 92 and a door vent operator 94 for opening and closing the door vent assembly 80.

The door vent member 84 is attached to the door frame 82 near the bottom of the door frame. The at least one third slot 86 of the door vent member 84 is open to the enclosed interior space of the cabinet.

The door vent baffle member 88 is positioned proximate (e.g., against) the door vent member 84. The at least one fourth slot 90 of the door vent baffle 88 is open to the outside ambient environment. The door vent baffle 88 is movable (e.g., slidable) relative to the door vent member 84 between an opened condition and a closed condition. The door vent operator 94 enables a user/operator to manipulate the door vent baffle between the opened and closed conditions.

In the opened condition, as shown in FIG. 5C, the at least one fourth slot 90 of the door vent baffle 88 at least partially aligns with the at least one third slot 86 of the door vent member 84; that is, the third 86 and fourth 90 slots at least partially overlap such that an air passage between the outside ambient environment and the enclosed interior space is created by the third 86 and fourth 90 slots. In the closed condition of the door vent baffle 88, the at least one fourth slot 90 does not align with the at least one third 86 slot; that is, the third 86 and fourth 90 slots do not overlap and the outside ambient environment and closed to the enclosed interior space 22 by way of the door vent assembly 80.

Similarly as previously discussed, it can be understood that the user/operator can manipulate the door vent operator 80 to control the amount of overlap between the third 86 and fourth 90 slots. As such, the door vent baffle 88 can be selectively movable by the user/operator from a closed condition (i.e., no overlap between the third 86 and fourth 90 slots) through at least a variety of partially opened conditions (i.e., where the overlap between the third 86 and fourth 90 slots is greater than zero but less than a maximum) to a fully opened condition (i.e., where the overlap between the third 86 and fourth 90 slots is at the maximum). Further, the door vent operator 94 can be associated with preset positions or indicia to aid the user/operator when manipulating the door vent operator 94 to open the door vent assembly 80.

The door vent assembly 80 can assist in humidity mitigation while the door 34 of the cabinet 10 remains closed. In this respect, air from the outside ambient environment (e.g., outside air) having a lower humidity than air inside the enclosed interior space 22 of the cabinet 10 can be introduced into the enclosed interior space 22 of the cabinet 10 by opening the door vent assembly 80. The outside air can then circulate through the cabinet 10 as previously described. When the cabinet vent 66 is opened without opening the door vent 90, the air exiting the rear vent 66 creates negative pressure inside of the cabinet. This limits the amount of humid air that is removed. By opening the door vent 90 with the cabinet vent 66, a cross-flow reduces the negative pressure and allows more humid air to escape.

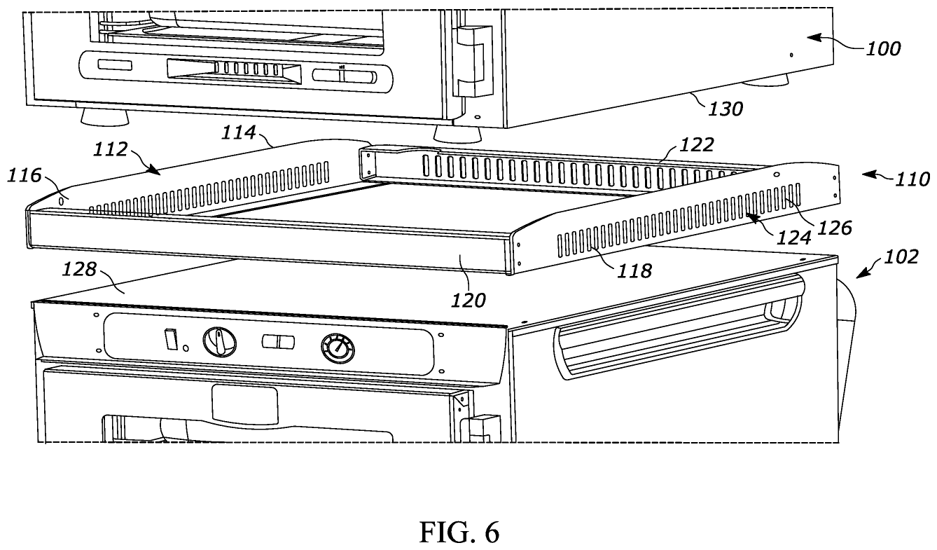

With reference to FIG. 6, an arrangement of a plurality of food holding and warming cabinets 10 of the present disclosure is shown. A first (upper) food holding and warming cabinet 100 can be stacked upon a second (lower) food holding and warming cabinet 102. To secure the stacked arrangement of cabinets, a stacking bracket 110 can be disposed intermediate the first food holding and warming cabinet 100 and the second food holding and warming cabinet 102. Although only two cabinets employing one stacking bracket 110 are illustrated in a stacking arrangement in FIG. 5, it can be appreciated that more than two cabinets employing more than one stacking bracket may be so arranged.

The stacking bracket 110 can include at least one vertical side wall 112 and at least one horizontal flange 114. As shown, the stacking bracket has four side walls-two opposed tall side walls 116, 118 and two opposed short side walls 120, 122. Some or all of the side walls can include a vent 124 comprising a slot 126 or a plurality of slots that can permit air flow (i.e., venting) in and out of the space between the stacked cabinets that is enclosed by the stacking brackets 110. Each side wall includes a horizontal flange 114 at a lower end of the side wall 116, 118. The bracket is fastened (e.g., with threaded fasteners) to an upper end 128 of the second (lower) food holding and warming cabinet 102 at the horizontal flanges 114. Additionally, the bracket 110 is fastened (e.g., with threaded fasteners) to a lower end 130 of the first (upper) food holding and warming cabinet 100 at vertical side walls.

Also illustrated in the figures, the food holding and warming cabinets 10 of the present disclosure may be configured to be stationary (e.g., having cabinet feet) or mobile (e.g., including wheels or casters).

Further, various sizes and door styles (solid or windowed) for the cabinets of the present disclosure are contemplated as exemplified in FIG. 1.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A food holding and warming cabinet comprising:
an insulated housing defining an enclosed interior space for receiving food;
a first venting chamber adjacent the enclosed interior space and including a first vent opening between the first venting chamber and the enclosed interior space and a second vent opening venting the first venting chamber to an ambient environment outside of the cabinet;
a duct extending between the venting chamber and the enclosed interior space;
a door attached to the housing and moveable between an open position, providing access to the enclosed interior space, and a closed position, preventing access to the enclosed interior space;
a heating system for heating the enclosed interior space including a convection heating component and a radiant heating component, the convection heating component includes:
a first heating element located within the duct; and
a fan located in the first venting chamber proximate to the first vent opening;
the fan is operable to create negative pressure within the enclosed interior space such that air is circulated through the duct, over the first heating element and into the enclosed interior space;
the radiant heating component has a second heating element disposed in the enclosed interior space; and
a user-operated humidity management system including:
a second venting chamber located adjacent to the first venting chamber, the second venting chamber including a third vent opening from the second venting chamber to the ambient environment outside of the cabinet; and
a baffle member selectively separating the second venting chamber from the first venting chamber, the baffle member is movable between an opened condition where air flow between the first venting chamber and the second venting chamber is allowed and a closed condition where air flow between the first venting chamber and the second venting chamber is prevented.

2. The food holding and warming cabinet of claim 1 further comprising a baffle operator connected to the baffle member; and
the first venting chamber includes a chamber wall with at least one first slot;
the baffle member includes at least one second slot and the baffle member is proximate the chamber wall and movable relative to the chamber wall;
in the opened condition the at least one second slot at least partially aligns with the at least one first slot;
in the closed condition the at least one second slot does not align with the at least one first slot; and
the baffle operator is operable to move the baffle member between the opened condition and the closed condition.

3. The food holding and warming cabinet of claim 1 wherein the door further comprises:
a door frame; and
a door vent assembly attached to the door frame, the door vent assembly comprising:
a door vent member with at least one third slot;
a door vent baffle member with at least one fourth slot, the door vent baffle member is proximate the door vent member and movable relative to the door vent member between an opened condition and a closed condition;
in the opened condition the at least one fourth slot at least partially aligns with the at least one third slot; and
in the closed condition the at least one fourth slot does not align with the at least one third slot.

4. The food holding and warming cabinet of claim 3 wherein the door vent assembly further comprises a door vent body, the door vent baffle member being slidable relative to the door vent body; and
a door vent operator operable to move the door vent baffle member between the opened condition and the closed condition.

5. The food holding and warming cabinet of claim 1 further comprising a plurality of wheels attached to a bottom of the housing.

6. The food holding and warming cabinet of claim 1 wherein the humidity management system further comprises a water bath located proximate to the second heating element.

7. An arrangement of a plurality of food holding and warming cabinets according to claim 1, wherein a first food holding and warming cabinet is stacked upon a second food holding and warming cabinet.

8. The arrangement according to claim 7, further comprising a bracket disposed intermediate the first food holding and warming cabinet and the second food holding and warming cabinet.

9. The arrangement according to claim 8, wherein the bracket comprises at least one vertical side wall and at least one horizontal flange;
the bracket is fastened to the first food holding and warming cabinet at the at least one vertical side wall; and
the bracket is fastened to the second food holding and warming cabinet at the at least one horizontal flange.

10. The arrangement according to claim 9, wherein the at least one vertical side wall includes a vent.
